(19) United States
(12) Patent Application Publication
(10) Pub. No.: US 2012/0152389 A1
(43) Pub. Date: Jun. 21, 2012

(54) Mixed Water Control Valve Having A Water Pressure Balance Function to Stabilize Water Temperature

(76) Inventor: Chia-Po Chang, Ho-Mei Town (TW)

(21) Appl. No.: 12/972,591

(22) Filed: Dec. 20, 2010

(51) Int. Cl. F16K 15/14

(52) U.S. Cl. 137/843

(57) ABSTRACT

A mixed water control valve for a faucet includes a control unit and a balance unit. The control unit includes a housing and a sealing cap mounted on the housing. The balance unit includes a fixed sleeve secured in the housing, a pressure regulating sleeve movably mounted in the fixed sleeve, a balance baffle mounted in the pressure regulating sleeve, and two elastic members each mounted in the pressure regulating sleeve and each biased between the balance baffle and a respective one of the housing and the sealing cap. Thus, the balance baffle is compressed between the elastic members which provide a buffering force to counteract the larger pressure applied on the balance baffle when the water only flows through one of two water inlet holes of the housing, so that the pressure regulating sleeve is moved smoothly and stably without producing resonant noise.

### BACKGROUND OF THE INVENTION

1. Field of the Invention

The present invention relates to a control valve and, more particularly, to a mixed water control valve for a faucet to control the temperature of a mixture of cold and hot water of the faucet.

2. Description of the Related Art

A conventional faucet comprises a control valve to mix the cold water from a cold water source and the hot water from a hot water source and to inject the mixed water outwardly for use with a user. Thus, the mixed water has a proper temperature so that the user can use the water comfortably. However, when the water flow from the cold water source or the hot water source is reduced or stops accidentally due to an irregular condition, the water pressure of the cold and hot water is not balanced, so that the water temperature is increased or decreasing to an excessive extent instantaneously to make the water too hot or too cold, thereby easily causing an uncomfortable sensation to the user due to the too cold water or evenly causing danger to the user due to the too hot water (the user is easily scalded by the too hot water).

A conventional control valve for a faucet comprises a control unit and a balance unit mounted in the control unit. The control unit includes a housing having an inner portion provided with a receiving chamber to receive the balance unit. The housing has a bottom provided with two water inlet holes and a water outlet hole. One of the two water inlet holes is connected to a cold water source, and the other one of the two water inlet holes is connected to a hot water source. The balance unit includes a hollow fixed sleeve secured in the receiving chamber of the housing and a pressure regulating sleeve movably mounted in the fixed sleeve. In operation, the cold water from the cold water source and the hot water from the hot water source in turn flow through the two water inlet holes and the fixed sleeve into the pressure regulating sleeve respectively. In such a manner, when the water flow of a first one (for example, the cold water terminal) of the water inlet holes is reduced accidentally or stopped abnormally due to an irregular condition, the water pressure of the first one (the cold water terminal) of the water inlet holes is reduced or disappears. Thus, the greater water pressure of a second one (for example, the hot water terminal) of the water inlet holes will push the pressure regulating sleeve so that the pressure regulating sleeve is moved in the fixed sleeve so as to reduce or stop the water flow of the second one (the hot water terminal) of the water inlet holes. Thus, the pressure regulating sleeve is moved by a pressure differential between the two water inlet holes so that the water flow of the two water inlet holes can be regulated by movement of the pressure regulating sleeve to achieve a water pressure balance and to stabilize the temperature of the mixed water in the valve housing. However, when the (cold or hot) water only flows through one of the two water inlet holes, while other water equipment is also opened simultaneously, a larger pressure is applied on the pressure regulating sleeve to push and move the pressure regulating sleeve violently, thereby easily producing a resonant noise in the faucet. In addition, the pressure regulating sleeve is moved quickly in the fixed sleeve due to the larger pressure so that the pressure regulating sleeve will hit or wear the fixed sleeve, thereby decreasing the lifetime of the balance unit.

### BRIEF SUMMARY OF THE INVENTION

In accordance with the present invention, there is provided a mixed water control valve, comprising a control unit and a balance unit mounted in the control unit. The control unit includes a housing having an inner portion provided with a receiving chamber to receive the balance unit, and a sealing cap mounted in the receiving chamber of the housing to seal the receiving chamber of the housing and to cover the balance unit. The balance unit includes a hollow fixed sleeve secured in the receiving chamber of the housing, a pressure regulating sleeve movably mounted in the fixed sleeve, a balance baffle mounted in the pressure regulating sleeve, and two elastic members each mounted in the pressure regulating sleeve and each biased between the balance baffle and a respective one of the housing and the sealing cap.

According to the primary advantage of the present invention, the balance baffle is compressed between the two elastic members which provide a buffering force to counteract the larger pressure applied on the balance baffle when the water only flows through one of the two water inlet holes of the housing, so that the pressure regulating sleeve is moved smoothly and stably without producing resonant noise in the faucet.

According to another advantage of the present invention, the pressure regulating sleeve is moved slowly in the fixed sleeve by buffering of the two elastic members so that the pressure regulating sleeve will not hit or wear the fixed sleeve so as to enhance the lifetime of the balance unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mixed water control valve for a faucet in accordance with the preferred embodiment of the present invention.

FIG. 2 is an exploded perspective view of the mixed water control valve for a faucet as shown in FIG. 1.

FIG. 3 is a front cross-sectional view of the mixed water control valve for a faucet as shown in FIG. 1.

FIG. 4 is a schematic operational view of the mixed water control valve for a faucet as shown in FIG. 3.

FIG. 5 is a schematic operational view of the mixed water control valve for a faucet as shown in FIG. 3.

### DETAILED DESCRIPTION OF THE INVENTION

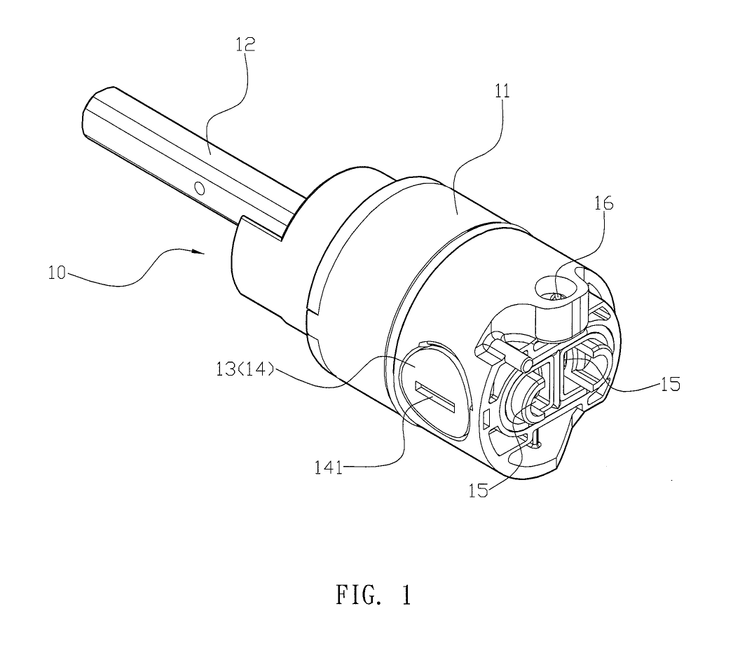

Referring to the drawings and initially to FIGS. 1-3, a control valve for a faucet in accordance with the preferred embodiment of the present invention comprises a control unit 10 and a balance unit 20 mounted in the control unit 10.

The control unit 10 includes a housing 11 having an inner portion provided with a receiving chamber 13 to receive the balance unit 20, a sealing cap 14 mounted in the receiving chamber 13 of the housing 11 to seal the receiving chamber 13 of the housing 11 and to cover the balance unit 20, a switching module adjustably mounted in the housing 11 to regulate a water flow in the housing 11, and a protruding control handle 12 rotatably mounted on the housing 11 and connected with the switching module to operate the switching module so as to open/close the water flow in the housing 11 or to change a mixed proportion of the hot and cold water in the housing 11.

The housing 11 of the control unit 10 has an end portion provided with two water inlet holes 15 and a water outlet hole 16. The two water inlet holes 15 of the housing 11 are connected to the receiving chamber 13 of the housing 11. One of the two water inlet holes 15 of the housing 11 is connected to a cold water source (not shown), and the other one of the two water inlet holes 15 of the housing 11 is connected to a hot water source (not shown). The receiving chamber 13 of the housing 11 has a peripheral wall provided with a locking groove 131. The sealing cap 14 of the control unit 10 is secured on the housing 11 and abuts the balance unit 20. The sealing cap 14 of the control unit 10 has an outer face provided with a tool slot 141 to allow insertion of a hand tool (not shown) so as to rotate the sealing cap 14 relative to the housing 11. The sealing cap 14 of the control unit 10 has a peripheral wall provided with a locking piece 142 that is snapped into and locked in the locking groove 131 of the housing 11 to lock the sealing cap 14 onto the housing 11.

The balance unit 20 is completely hidden in the receiving chamber 13 of the housing 11 and is stopped by the sealing cap 14. The balance unit 20 includes a hollow fixed sleeve 21 secured in the receiving chamber 13 of the housing 11, a pressure regulating sleeve 22 movably mounted in the fixed sleeve 21, a balance baffle 222 mounted in the pressure regulating sleeve 22, and two elastic members 23 each mounted in the pressure regulating sleeve 22 and each biased between the balance baffle 222 and a respective one of the housing 11 and the sealing cap 14.

The fixed sleeve 21 of the balance unit 20 is located between the housing 11 and the sealing cap 14 of the control unit 10. The fixed sleeve 21 of the balance unit 20 has a periphery provided with two connecting grooves 211 each connected to a respective one of the two water inlet holes 15 of the housing 11.

The pressure regulating sleeve 22 of the balance unit 20 has a periphery provided with two connecting slots 223 each movable to align or partially align with a respective one of the two connecting grooves 211 of the fixed sleeve 21. The pressure regulating sleeve 22 of the balance unit 20 has an inner portion provided with two receiving spaces 221 to receive the two elastic members 23. Each of the two receiving spaces 221 of the pressure regulating sleeve 22 is connected to a respective one of the two connecting slots 223 and is connected to a respective one of the housing 11 and the sealing cap 14.

The balance baffle 222 of the balance unit 20 is located at a middle position of the pressure regulating sleeve 22 and is located between the two receiving spaces 221. The balance baffle 222 of the balance unit 20 is also located between the two connecting slots 223. The balance baffle 222 of the balance unit 20 is compressed between the two elastic members 23 so that the pressure regulating sleeve 22 of the balance unit 20 is kept at a middle position of the fixed sleeve 21 by the two elastic members 23.

Each of the two elastic members 23 of the balance unit 20 is a compression spring which is received in a respective one of the two receiving spaces 221 of the pressure regulating sleeve 22. One of the two elastic members 23 of the balance unit 20 has a first end pressing the balance baffle 222 and a second end pressing a sidewall of the receiving chamber 13 of the housing 11, and the other one of the two elastic members 23 of the balance unit 20 has a first end pressing the balance baffle 222 and a second end pressing the sealing cap 14.

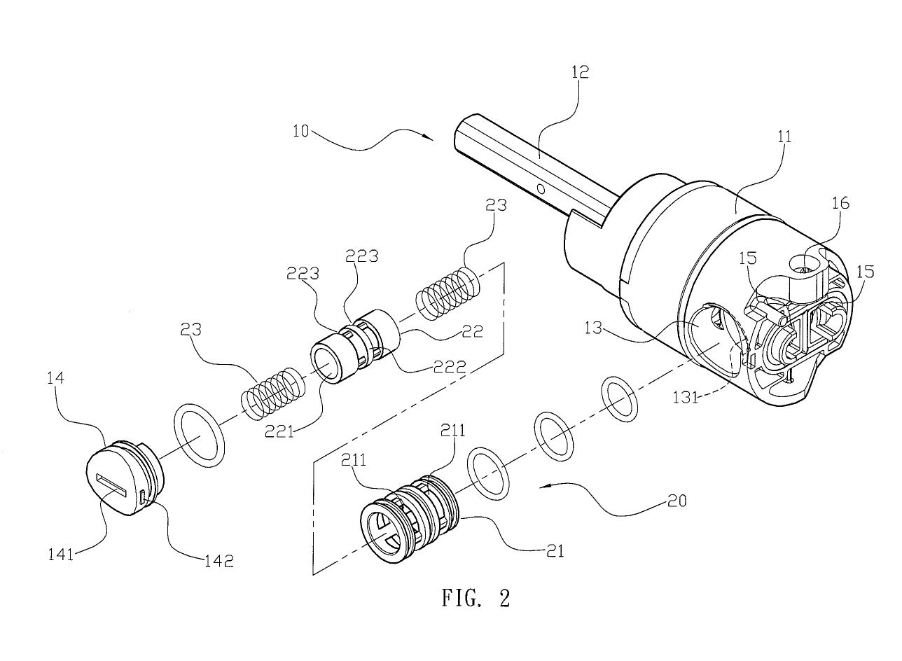

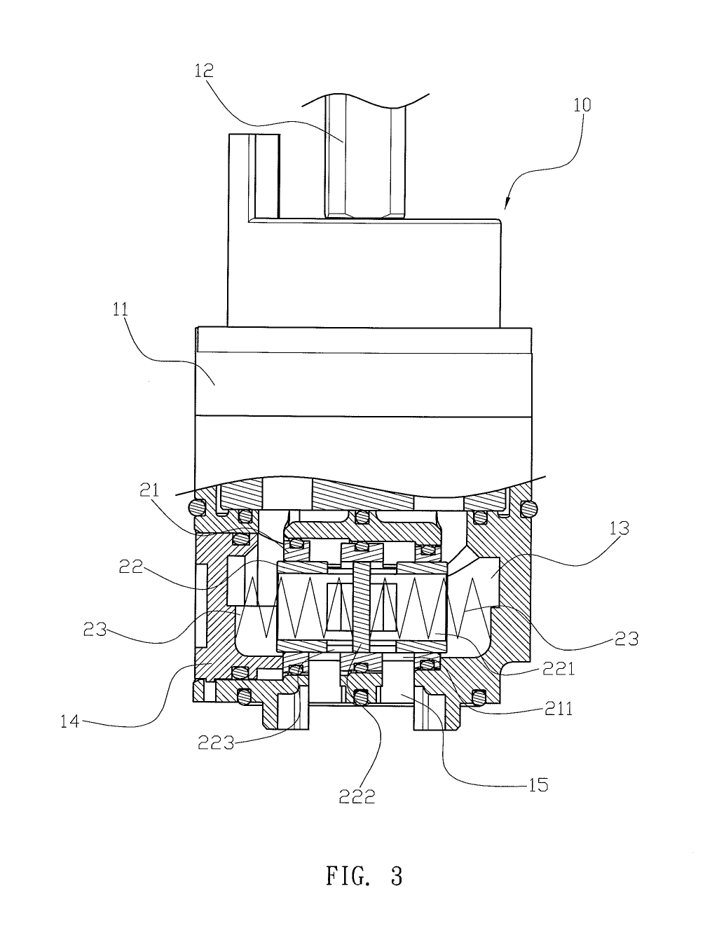

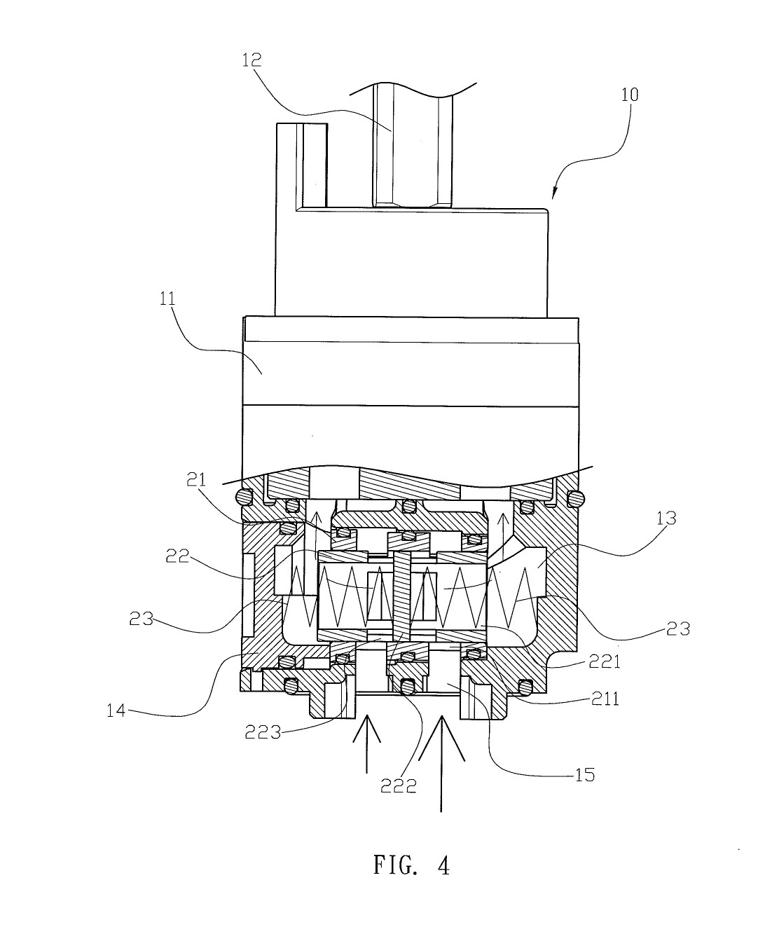

In operation, referring to FIGS. 3 and 4 with reference to FIGS. 1 and 2, the cold water from the cold water source and the hot water from the hot water source in turn flow through the two water inlet holes 15 of the housing 11, the two connecting grooves 211 of the fixed sleeve 21 and the two connecting slots 223 of the pressure regulating sleeve 22 into the two receiving spaces 221 of the pressure regulating sleeve 22 respectively. In such a manner, when the water flow of a first one (for example, the cold water terminal) of the two water inlet holes 15 of the housing 11 is reduced accidentally or stopped abnormally due to an irregular condition, the water pressure of the first one (the cold water terminal) of the water inlet holes 15 is reduced or disappears. Thus, the greater water pressure of a second one (for example, the hot water terminal) of the two water inlet holes 15 of the housing 11 will push the balance baffle 222 of the balance unit 20 toward the first one (the cold water terminal) of the water inlet holes 15, so that the pressure regulating sleeve 22 is moved in the fixed sleeve 21 to reduce or block the overlapping area of the respective connecting groove 211 of the fixed sleeve 21 and the respective connecting slot 223 of the pressure regulating sleeve 22 at the second one (the hot water terminal) of the water inlet holes 15 so as to reduce or stop the water flow of the second one (the hot water terminal) of the water inlet holes 15. Thus, the pressure regulating sleeve 22 is moved by a pressure differential between the two water inlet holes 15 of the housing 11 so that the water flow of the two water inlet holes 15 can be regulated by movement of the pressure regulating sleeve 22 so as to achieve a water pressure balance and to stabilize the temperature of the mixed water in the valve housing 11.

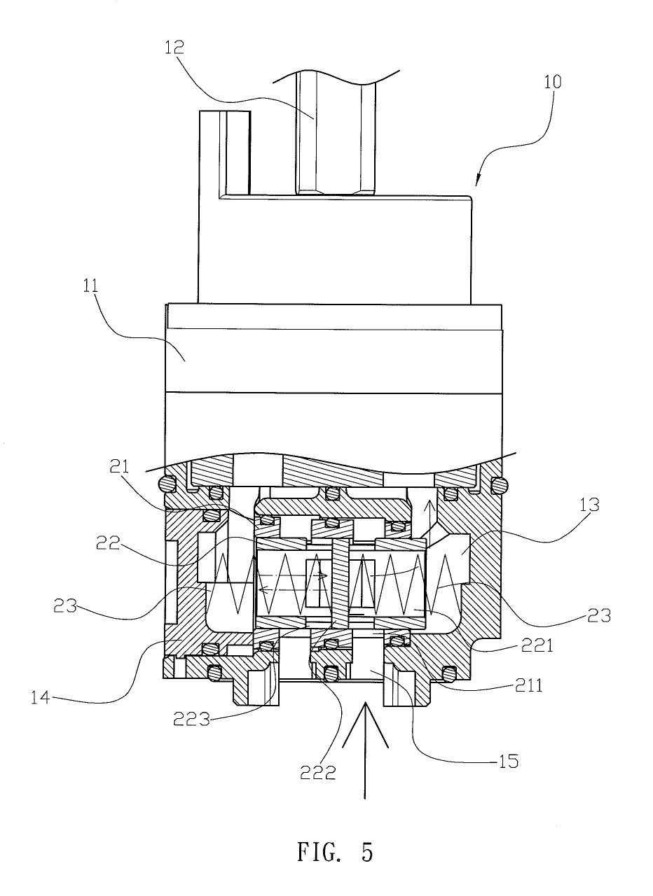

As shown in FIG. 5, the (cold or hot) water only flows through one of the two water inlet holes 15 of the housing 11, while other water equipment is also opened simultaneously so that a larger pressure is applied on the balance baffle 222 to push and move the pressure regulating sleeve 22 violently. At this time, the two elastic members 23 press the balance baffle 222 to provide a buffering force to counteract the larger pressure applied on the balance baffle 222 so that the pressure regulating sleeve 22 is moved smoothly and stably without producing resonant noise in the faucet. In addition, the pressure regulating sleeve 22 is moved slowly in the fixed sleeve 21 so that the pressure regulating sleeve 22 will not hit or wear the fixed sleeve 21 so as to enhance the lifetime of the balance unit 20.

Accordingly, the balance baffle 222 is compressed between the two elastic members 23 which provide a buffering force to counteract the larger pressure applied on the balance baffle 222 when the water only flows through one of the two water inlet holes 15, so that the pressure regulating sleeve 22 is moved smoothly and stably without producing resonant noise in the faucet. In addition, the pressure regulating sleeve 22 is moved slowly in the fixed sleeve 21 by buffering of the two elastic members 23 so that the pressure regulating sleeve 22 will not hit or wear the fixed sleeve 21 so as to enhance the lifetime of the balance unit 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A mixed water control valve, comprising:
a control unit; and
a balance unit mounted in the control unit;
the control unit includes:
a housing having an inner portion provided with a receiving chamber to receive the balance unit; and
a sealing cap mounted in the receiving chamber of the housing to seal the receiving chamber of the housing and to cover the balance unit;
the balance unit includes:
a hollow fixed sleeve secured in the receiving chamber of the housing;
a pressure regulating sleeve movably mounted in the fixed sleeve;
a balance baffle mounted in the pressure regulating sleeve; and
two elastic members each mounted in the pressure regulating sleeve and each biased between the balance baffle and a respective one of the housing and the sealing cap.

2. The mixed water control valve of claim 1, wherein
the housing of the control unit has an end portion provided with two water inlet holes and a water outlet hole;
the two water inlet holes of the housing are connected to the receiving chamber of the housing;
the fixed sleeve of the balance unit has a periphery provided with two connecting grooves each connected to a respective one of the two water inlet holes of the housing;
the pressure regulating sleeve of the balance unit has a periphery provided with two connecting slots each movable to align or partially align with a respective one of the two connecting grooves of the fixed sleeve;
the pressure regulating sleeve of the balance unit has an inner portion provided with two receiving spaces to receive the two elastic members;
each of the two receiving spaces of the pressure regulating sleeve is connected to a respective one of the two connecting slots and is connected to a respective one of the housing and the sealing cap;
the balance baffle of the balance unit is located at a middle position of the pressure regulating sleeve and is located between the two receiving spaces;
the balance baffle of the balance unit is located between the two connecting slots;
the balance baffle of the balance unit is compressed between the two elastic members;
the pressure regulating sleeve of the balance unit is kept at a middle position of the fixed sleeve by the two elastic members;
each of the two elastic members of the balance unit is a compression spring which is received in a respective one of the two receiving spaces of the pressure regulating sleeve;
one of the two elastic members of the balance unit has a first end pressing the balance baffle and a second end pressing a sidewall of the receiving chamber of the housing;
the other one of the two elastic members of the balance unit has a first end pressing the balance baffle and a second end pressing the sealing cap.

3. The mixed water control valve of claim 1, wherein
the receiving chamber of the housing has a peripheral wall provided with a locking groove;
the sealing cap of the control unit is secured on the housing and abuts the balance unit;
the sealing cap of the control unit has an outer face provided with a tool slot;
the sealing cap of the control unit has a peripheral wall provided with a locking piece that is snapped into and locked in the locking groove of the housing to lock the sealing cap onto the housing.

4. The mixed water control valve of claim 1, wherein
the balance unit is completely hidden in the receiving chamber of the housing and is stopped by the sealing cap;
the fixed sleeve of the balance unit is located between the housing and the sealing cap of the control unit;
the control unit further includes:
a switching module adjustably mounted in the housing to regulate a water flow in the housing; and
a protruding control handle rotatably mounted on the housing and connected with the switching module to operate the switching module so as to open/close the water flow in the housing or to change a mixed proportion of the hot and cold water in the housing.
